(19) United States
(12) Patent Application Publication
(10) Pub. No.: US 2018/0037166 A1
(43) Pub. Date: Feb. 8, 2018

(54) Hitch Mounted Entry Step

(71) Applicant: Lance Camper Mfg. Corp., Lancaster, CA (US)

(72) Inventor: Randy Harding Hunter, Lancaster, CA (US)

(21) Appl. No.: 15/668,134

(22) Filed: Aug. 3, 2017

Related U.S. Application Data
(60) Provisional application No. 62/370,585, filed on Aug. 3, 2016.

(51) Int. Cl. B60R 3/00; B60R 9/06; B60R 3/02

(52) U.S. Cl. CPC B60R 3/007; B60R 3/02; B60R 9/06; B60R 3/00; B60R 9/00

(57) ABSTRACT

A hitch step system including: a hitch step comprising a top surface and a bottom surface; a hitch step support fixedly attached to the hitch step; a saddle fixedly attached to the hitch step support and detachably attachable to a hitch receiver tube such that an open end of the hitch receiver tube is available to accept a hitch attachment; and a flip-down step disposed above the hitch step in a first position and below the hitch step in the second position, wherein the flip-down step is detachably attached to the bottom surface of the hitch step by a plurality of pivoting brackets rotatably attached to flip-down step attachment brackets.

### CROSS-REFERENCE TO RELATED APPLICATIONS

This application claims priority to and benefit of Provisional Patent Application No. 62/370,585 filed Aug. 3, 2016, which is hereby incorporated by reference for all purposes.

### TECHNICAL FIELD

The invention, in its several embodiments, pertains to hitches, and more particularly to trailer hitch attachments.

### BACKGROUND

Trailer hitches may be used to attach vehicles for towing. Trailer hitches may also be used to attach accessories, such as bike racks and cargo carriers. A single trailer hitch may only be used to attach a single vehicle or accessory.

### SUMMARY

A hitch step system is disclosed herein including: a hitch mount configured to be mounted to a hitch receiver tube; wherein the hitch mount has a body comprises an opening for slidably receiving a portion of the hitch receiver tube therein; and wherein an open end of the hitch receiver tube remains available to receive a hitch attachment. The hitch mount body may include a sleeve element. The sleeve element may include a plurality of threaded openings. The system may also include a plurality of fasteners, where the plurality of fasteners are inserted through the plurality of threaded openings to urge the plurality of fasteners against at least one wall of the hitch receiver tube within the sleeve element such that the sleeve element remains stationary relative to the hitch receiver tube.

In another system embodiment, the hitch mount body comprises a saddle element. The saddle element may be fixedly attached to a hitch step support. The hitch step support may include a first support frame member, a second support frame member, a third support frame member, a fourth support frame member, a fifth support frame member, and a sixth support frame member. The first support frame member, the second support frame member, and the third support frame member may all be substantially parallel along a longitudinal axis; where the fourth support frame member may be substantially perpendicular to the first and second support frame members; and where the fifth and sixth support frame members may be substantially perpendicular to both the fourth support frame member and the third support frame member. The third frame member may be fixedly attached to the saddle.

In some system embodiments, the hitch step support may have an adjustable vertical height relative to the hitch receiver tube. The system may also include a hitch step including a top surface and a bottom surface, where the hitch step support may be attached to the hitch step. The system may also include a flip-down step disposed above the hitch step in a first position and below the hitch step in the second position. Some system embodiments may include a plurality of pivoting brackets, where the flip-down step may be detachably attached to the bottom surface of the hitch step by the plurality of pivoting brackets rotatably attached to flip-down step attachment brackets.

The saddle element may include a plurality of apertures, and the saddle element may be secured about the hitch receiver tube via a plurality of fasteners fitting through the apertures in side walls of the saddle. The saddle element may include two pairs of side walls and spacer plates attached to the hitch step support, where the spacer plates and side walls of the saddle may be substantially parallel to one another and form an opening for receiving a portion of the hitch receiver tube having a substantially constant width.

An exemplary hitch step system including: a hitch step comprising a top surface and a bottom surface; a hitch step support fixedly attached to the hitch step; a saddle fixedly attached to the hitch step support and detachably attachable to a hitch receiver tube such that an open end of the hitch receiver tube is available to accept a hitch attachment; and a flip-down step disposed above the hitch step in a first position and below the hitch step in the second position, wherein the flip-down step is detachably attached to the bottom surface of the hitch step by a plurality of pivoting brackets rotatably attached to flip-down step attachment brackets.

### BRIEF DESCRIPTION OF THE DRAWINGS

Embodiments of the present invention are illustrated by way of example and not limitation in the figures of the accompanying drawings, which may not be drawn to scale, and in which:

FIG. 1A shows a top plan view of an exemplary flip down step of a hitch step system disclosed herein, according to one embodiment;

FIG. 1B shows a front elevational view of the exemplary flip down step of FIG. 1A, according to one embodiment;

FIG. 1C shows a right side elevational view of the exemplary flip down step of FIG. 1A, according to one embodiment;

FIG. 1D shows a detail of a pivoting bracket about A in FIG. 1C, according to one embodiment;

FIG. 1E shows a perspective view of the exemplary flip down step of FIG. 1A, according to one embodiment;

FIG. 2A shows a top unassembled view of an exemplary hitch step of the exemplary hitch step system, according to one embodiment;

FIG. 2B shows a detail view of mounting holes detail A in FIG. 2A, according to one embodiment;

FIG. 3A shows a bottom plan view of a formed exemplary hitch step of the exemplary hitch step system, according to one embodiment;

FIG. 3B shows a front elevational view of the exemplary hitch step of FIG. 3A, according to one embodiment;

FIG. 3C shows a right side elevational view of the exemplary hitch step of FIG. 3A, according to one embodiment;

FIG. 3D shows a perspective view of the exemplary hitch step of FIG. 3A, according to one embodiment;

FIG. 4A shows a top plan view of an exemplary hitch step support of the exemplary hitch step system, according to one embodiment;

FIG. 4B shows a front elevational view of the exemplary hitch step support of FIG. 4A, according to one embodiment;

FIG. 4C shows a right side elevational view of the exemplary hitch step support of FIG. 4A, according to one embodiment;

FIG. 4D shows a perspective view of the exemplary hitch step support of FIG. 4A, according to one embodiment;

FIG. 5A shows a front elevational view of a hitch stair including the exemplary hitch step of FIG. 3A attached to the exemplary hitch step support of FIG. 4A, wherein hidden parts shown in dashed lines, according to one embodiment;

FIG. 5B shows a bottom plan view of the exemplary hitch stair of FIG. 5A, with hidden parts shown in dashed lines, according to one embodiment;

FIG. 5C shows a right side elevational view of the hitch stair of FIG. 5A, with hidden parts shown in dashed lines, according to one embodiment;

FIG. 5D shows a perspective view of the hitch stair of FIG. 5A, according to one embodiment;

FIG. 6A shows an exemplary mounting plate of a saddle of the exemplary hitch step system, according to one embodiment;

FIG. 6B shows an exemplary spacer plate of the saddle of the exemplary hitch step system, according to one embodiment;

FIG. 6C shows a perspective view of the exemplary mounting plate of FIG. 6A attached to the exemplary spacer plate of FIG. 6B, according to one embodiment;

FIG. 6D shows a top view of the exemplary mounting plate of FIG. 6A and exemplary spacer plate of FIG. 6B mounted on either side of the exemplary hitch step support of FIG. 4A, according to one embodiment;

FIG. 6E shows a cross-sectional view of the exemplary mounting plate of FIG. 6A and exemplary spacer plate of FIG. 6B attached on either side of the exemplary hitch step support of FIG. 4A, according to one embodiment;

FIG. 6F shows a right side elevational view of the exemplary mounting plate of FIG. 6A attached to the exemplary hitch step support of FIG. 4A, according to one embodiment;

FIG. 7A shows a top unassembled view of an alternate exemplary hitch step of an alternate exemplary hitch step system, according to one embodiment;

FIG. 7B shows a detail view of mounting holes about A in FIG. 7A, according to one embodiment;

FIG. 8A shows a bottom plan view of an alternate formed exemplary hitch step of the alternate exemplary hitch step system, according to one embodiment;

FIG. 8B shows a front elevational view of the alternate exemplary hitch step of FIG. 8A, according to one embodiment;

FIG. 8C shows a right side elevational view of the alternate exemplary hitch step of FIG. 8A, according to one embodiment;

FIG. 8D shows a perspective view of the alternate exemplary hitch step of FIG. 8A, according to one embodiment;

FIG. 9A shows a top plan view of an alternate exemplary hitch step support having an adjustable vertical height of the alternate exemplary hitch step system, according to one embodiment;

FIG. 9B shows a front elevational view of the alternate exemplary hitch step support of FIG. 9A, according to one embodiment;

FIG. 9C shows a right side elevational view of the alternate exemplary hitch step support of FIG. 9A, according to one embodiment;

FIG. 9D shows a perspective view of the alternate exemplary hitch step support of FIG. 9A, according to one embodiment;

FIG. 10A shows a front elevational view of the alternate exemplary hitch step of FIG. 8A and the alternate exemplary hitch step support of FIG. 9A, with hidden parts shown in dashed lines, according to one embodiment;

FIG. 10B shows a bottom plan view of the alternate exemplary hitch step of FIG. 8A and the alternate exemplary hitch step support of FIG. 9A, with hidden parts shown in dashed lines, according to one embodiment;

FIG. 10C shows a right side elevational view of the alternate exemplary hitch step of FIG. 8A and the alternate exemplary hitch step support of FIG. 9A, with hidden parts shown in dashed lines, according to one embodiment;

FIG. 10D shows a perspective view of the alternate exemplary hitch step of FIG. 8A and the alternate exemplary hitch step support of FIG. 9A, according to one embodiment;

FIG. 11A shows an alternate exemplary mounting plate of an alternate saddle of the alternate exemplary hitch step system, according to one embodiment;

FIG. 11B shows an alternate exemplary spacer plate of the alternate saddle of the alternate exemplary hitch step system, according to one embodiment;

FIG. 11C shows a perspective view of the alternate exemplary mounting plate of FIG. 6A attached to the alternate exemplary spacer plate of FIG. 6B, according to one embodiment;

FIG. 11D shows a top view of the alternate exemplary mounting plate of FIG. 6A and alternate exemplary spacer plate of FIG. 6B mounted on either side of the alternate exemplary hitch step support of FIG. 9A, according to one embodiment;

FIG. 11E shows a cross-sectional view of the alternate exemplary mounting plate of FIG. 11A and alternate exemplary spacer plate of FIG. 11B attached on either side of the alternate exemplary hitch step support of FIG. 9A, according to one embodiment;

FIG. 11F shows a right side elevational view of the alternate exemplary mounting plate of FIG. 11A attached to the alternate exemplary hitch step support of FIG. 9A, according to one embodiment;

FIG. 12 shows a perspective view of the exemplary hitch step system, according to one embodiment;

FIG. 13 shows another perspective view of the exemplary hitch step system, according to one embodiment;

FIG. 14 shows a perspective view of the exemplary pivoting bracket of the exemplary flip down step limiting further rotational movement of the exemplary flip down step relative to the exemplary hitch step, according to one embodiment;

FIG. 15 shows a perspective view of the exemplary flip down step in a first position, according to one embodiment;

FIG. 16 shows a perspective view of the exemplary pivoting bracket of the flip down step, according to one embodiment;

FIG. 17 shows a perspective view of the exemplary hitch step system relative to a door in a recreational vehicle (RV), according to one embodiment;

FIG. 18 shows a perspective view of the exemplary hitch step support and exemplary saddle attached to a hitch receiver tube of a hitch receiver, according to one embodiment;

FIG. 19 shows a bottom view of the exemplary hitch step support and exemplary saddle attached to a hitch receiver tube of a hitch receiver, according to one embodiment;

FIG. 20 shows a perspective view of the exemplary hitch step of FIG. 3A and the exemplary hitch step support of FIG. 4A, according to one embodiment;

FIG. 21 shows a perspective view of the saddle of the exemplary hitch step system attached to the hitch receiver tube of the hitch receiver, according to one embodiment;

FIG. 22 shows an additional perspective view of the saddle of the exemplary hitch step system attached to the hitch receiver tube of the hitch receiver, according to one embodiment;

FIG. 23 shows a perspective view of the exemplary hitch step system with the exemplary flip down step in a lowered or second position, according to one embodiment;

FIG. 24 shows a perspective view of the exemplary hitch step system with the exemplary flip down step being lowered, according to one embodiment; and

FIG. 25 shows a perspective view of the exemplary hitch step system, according to one embodiment.

### DETAILED DESCRIPTION

The description herein is made for the purpose of illustrating the general principles of the embodiments discloses herein and is not meant to limit the concepts disclosed herein. Further, particular features described herein can be used in combination with other described features in each of the various possible combinations and permutations. Unless otherwise specifically defined herein, all terms are to be given their broadest possible interpretation including meanings implied from the description as well as meanings understood by those skilled in the art and/or as defined in dictionaries, treatises, etc.

A hitch step system is disclosed herein including: a hitch mount configured to be mounted to a hitch receiver tube; where the hitch mount has a body comprising an opening for slidably receiving a portion of the hitch receiver tube therein; and where an open end of the hitch receiver tube remains available to receive a hitch attachment. In one embodiment, the hitch mount body comprises a sleeve element. The sleeve element may include a plurality of threaded openings. The system may also include a plurality of fasteners, where the plurality of fasteners are inserted through the plurality of threaded openings to urge the plurality of fasteners against at least one wall of the hitch receiver tube within the sleeve element such that the sleeve element remains stationary relative to the hitch receiver tube.

In another system embodiment, the hitch mount body comprises a saddle element. The saddle element may be fixedly attached to a hitch step support. The hitch step support may include a first support frame member, a second support frame member, a third support frame member, a fourth support frame member, a fifth support frame member, and a sixth support frame member. The first support frame member, the second support frame member, and the third support frame member may all be substantially parallel along a longitudinal axis; where the fourth support frame member may be substantially perpendicular to the first and second support frame members; and where the fifth and sixth support frame members may be substantially perpendicular to both the fourth support frame member and the third support frame member. The third frame member may be fixedly attached to the saddle.

In some system embodiments, the hitch step support may have an adjustable vertical height relative to the hitch receiver tube. The system may also include a hitch step including a top surface and a bottom surface, where the hitch step support may be attached to the hitch step. The system may also include a flip-down step disposed above the hitch step in a first position and below the hitch step in the second position. Some system embodiments may include a plurality of pivoting brackets, where the flip-down step may be detachably attached to the bottom surface of the hitch step by the plurality of pivoting brackets rotatably attached to flip-down step attachment brackets.

The saddle element may include a plurality of apertures, and the saddle element may be secured about the hitch receiver tube via a plurality of fasteners fitting through the apertures in side walls of the saddle. The saddle element may include two pairs of side walls and spacer plates attached to the hitch step support, where the spacer plates and side walls of the saddle may be substantially parallel to one another and form an opening for receiving a portion of the hitch receiver tube having a substantially constant width.

A hitch step system is disclosed herein including a hitch step mounted on a hitch step support, according to one embodiment. The hitch step support is attached to a hitch receiver tube of a hitch receiver via a saddle. Accordingly, the hitch receiver may still be used to accept additional accessories, such as a bike rack or a cargo carrier, while providing a step for entry to a recreational vehicle (RV) or another vehicle having a hitch receiver mounted thereon.

In some embodiments, the hitch step system may include a flip-down step. The flip down step may be stored above the hitch step in a first position. The flip down step may rotate into a second position located below the hitch step in order to provide easier access to the hitch step and entry to the RV or another vehicle. The flip down step may have a pivoting bracket that prevents the hitch step from swinging down during the transition from the first position to the second position, which could cause injury to a user. The flip down step may be secured in the first position when not in use.

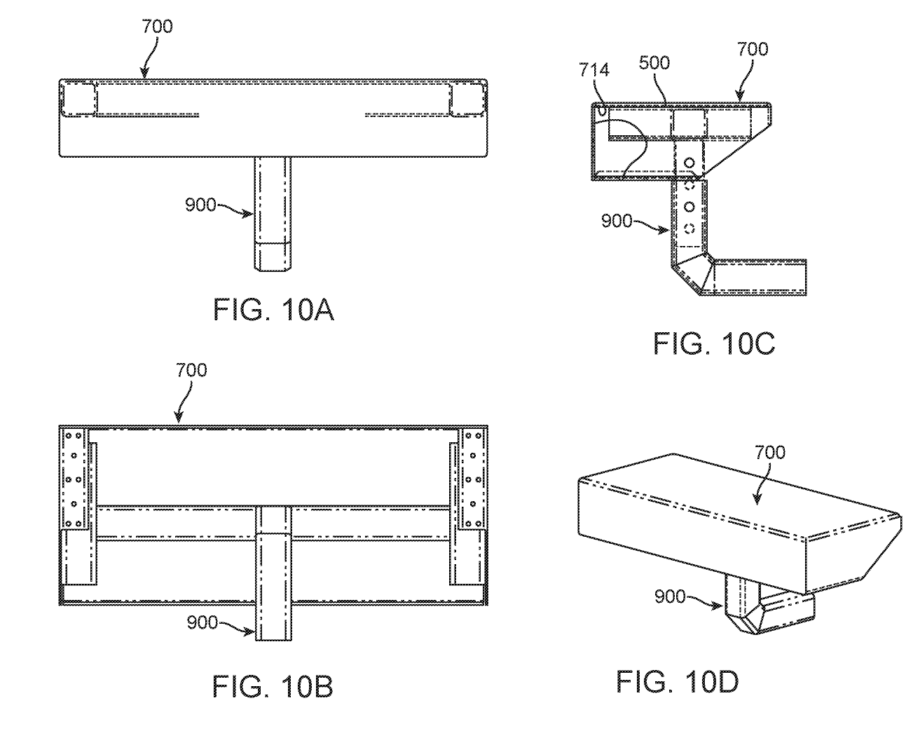

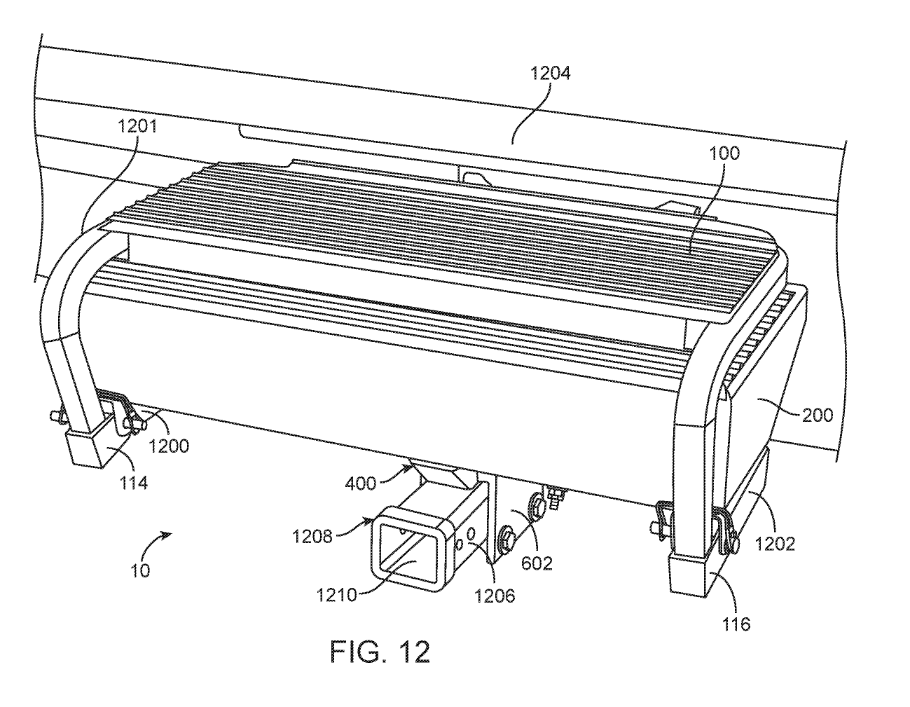

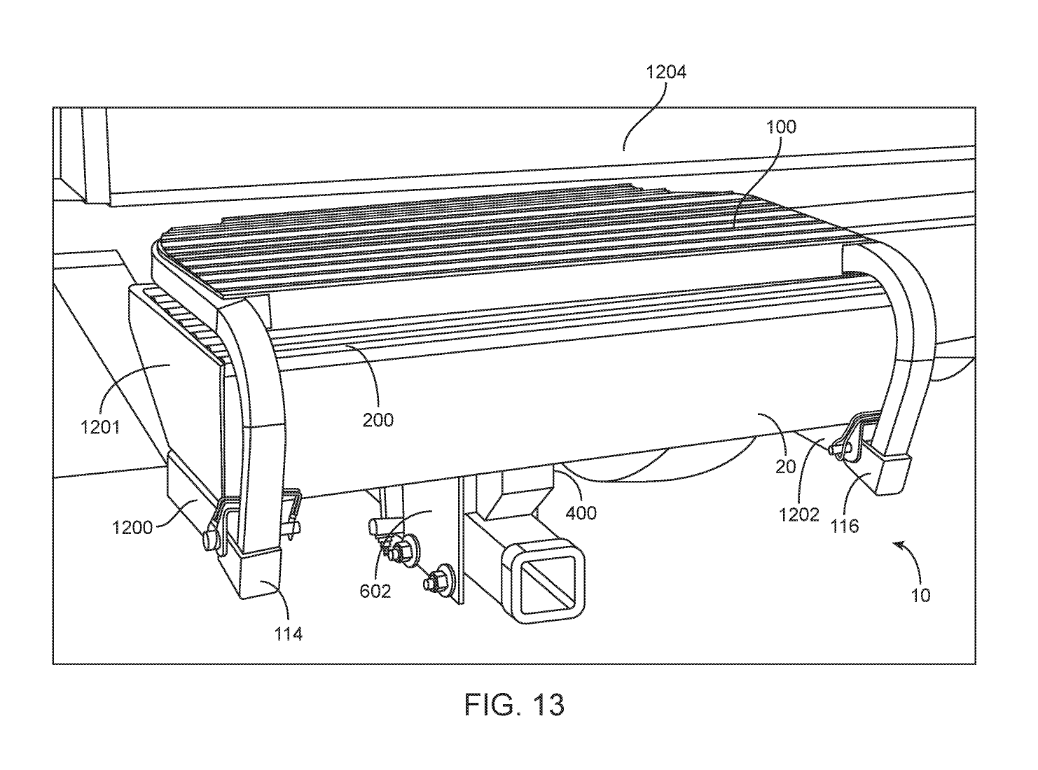

As shown by example in FIGS. 12-13, in one embodiment, the hitch step system 10 (FIGS. 12-13) includes a flip down step 100, and a hitch stair 20. In one embodiment the flip down step is rotatably mounted on the hitch stair 20. As shown by example in FIG. 10D, in one embodiment the hitch stair 20 includes a hitch step 200 and hitch step support 400. In embodiment of the hitch step system 10, the flip down step 100 is optional.

In one embodiment, the hitch step support 400 includes a saddle mount 602 (saddle) having a U-shaped cross section, wherein an open side of the saddle mount 602 receives a hitch receiver tube 1206 of a hitch receiver, as shown by example in FIGS. 12, 18, 19, 21, 22. In this example, the saddle mount 602 has three connected walls and an open side.

Further, in this example, the hitch receiver tube 1206 has an essentially rectangular (e.g., square) cross-section. The saddle mount 602 is sized and shaped such that the hitch receiver tube 1206 nestles into the U-shaped saddle mount 602. In other words, the U-shaped saddle mount 602 straddles the receiver tube 1206 from the open side of the saddle mount 602. One or more spacer plates 604 are used for a snug fit, as described further below. In one embodiment, each spacer plate is positioned between a side wall 600 of the saddle mount 602 and a body/wall of the hitch step support 400. In one embodiment, a spacer plate 604 is welded between the saddle mount plate 602 and a wall/body of the hitch step support 400.

In one embodiment, the saddle mount 602 comprises a U-shaped saddle comprises a U-shaped bracket attached to the support 400 at frame 406. In another embodiment, shown in the drawings, the U-shaped saddle mount 602 comprises side walls 600 and a top wall 406, wherein the wall 406 may be a frame member 406 of the hitch step support 400 as shown. The side walls 600 are affixed to the sides of the member 406 which has a rectangular (e.g., square) cross-section.

In other embodiment, the saddle mount 602 may be sized and shaped to have a cross-section generally matching the cross-section of the hitch tube 1206, such that the saddle mount 602 can straddle the hitch tube 1206.

As such, hitch step support 400 is maintained and supported by the hitch receiver tube via the saddle mount 602. The saddle mount 602 is used to detachably attach the hitch step system to a hitch receiver tube of a hitch receiver as shown by example in FIGS. 12, 18, 19, 21, 22.

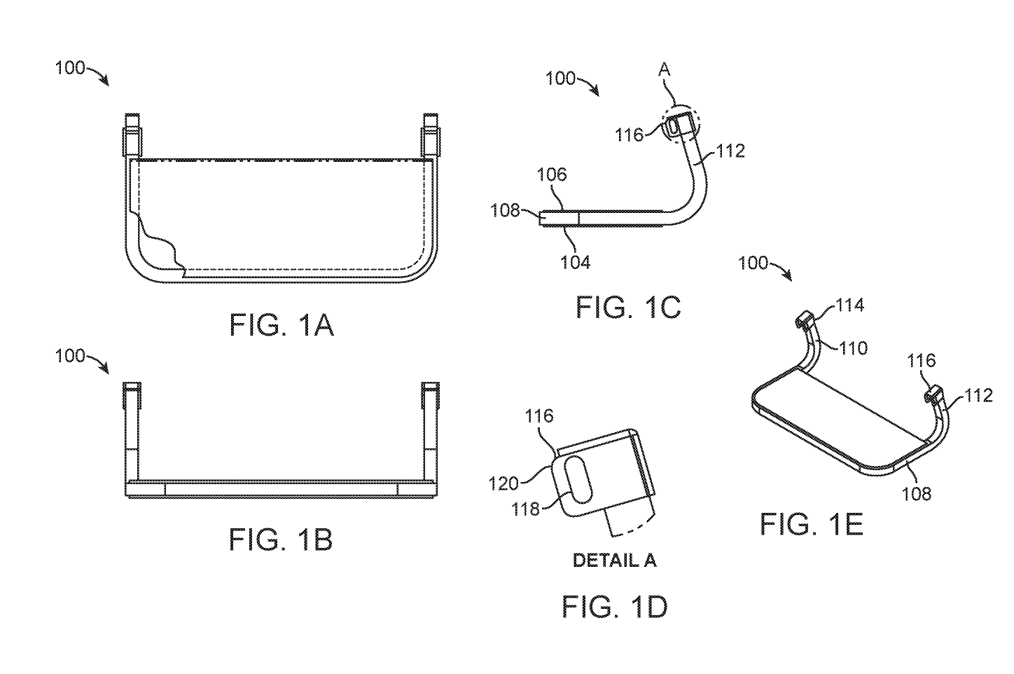

FIGS. 1A through 6F show an exemplary hitch step system having a fixed vertical height relative to a hitch receiver, according to one embodiment. Specifically, FIG. 1A shows a top plan view of an exemplary flip down step 100 of an exemplary hitch step system 10. FIG. 1B shows a front elevational view of the exemplary flip down step 100 of FIG. 1A. FIG. 1C shows a right side elevational view of the exemplary flip down step 100 of FIG. 1A. FIG. 1D shows a detail of a pivoting bracket 110, 112 for detail A in FIG. 1C. FIG. 1E shows a perspective view of the exemplary flip down step 100 of FIG. 1A.

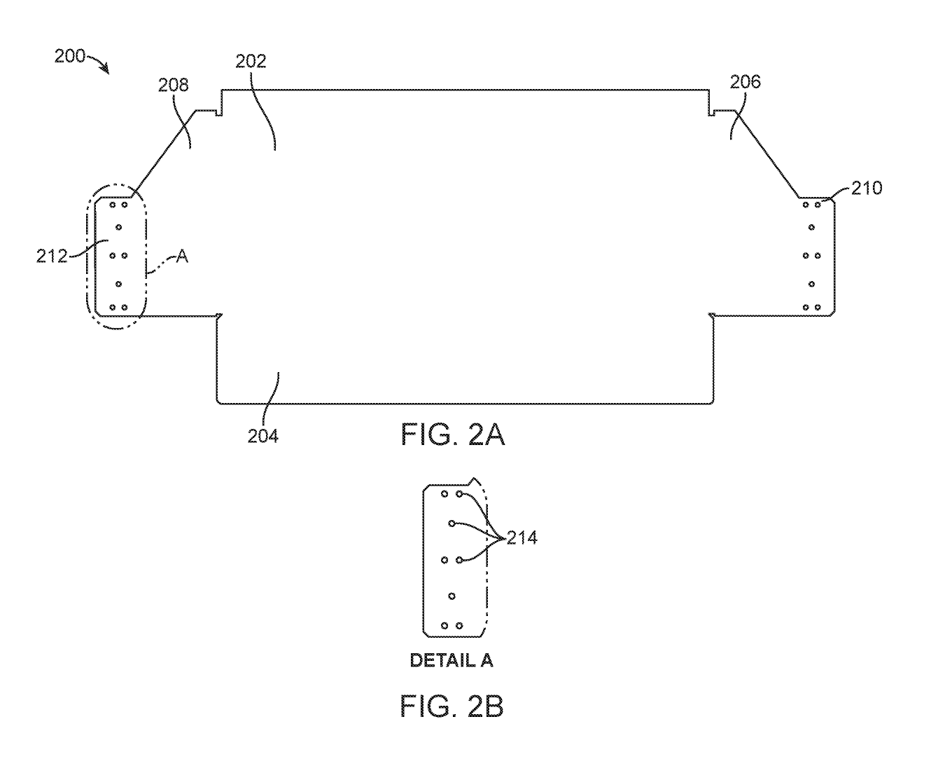

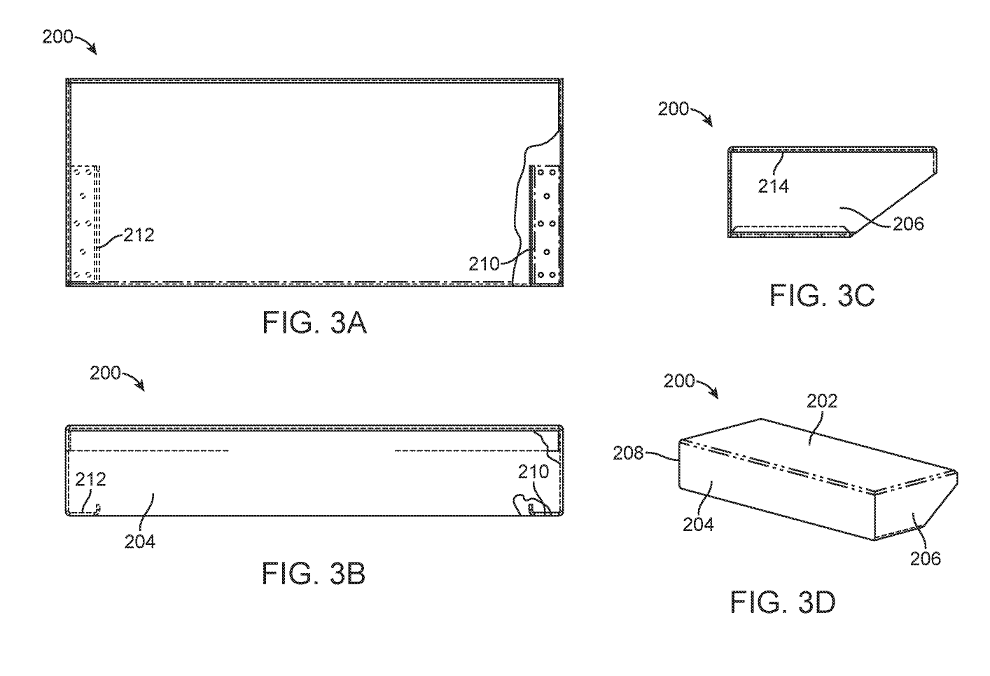

The exemplary flip down step 100 may have a non-slip surface applied to a first surface 104 and a second surface 106. The first surface 104 may be disposed above, and substantially parallel with, a top surface of the hitch step (FIGS. 2A-3D) in a first position. When the flip down step 100 is rotated into a second position, the second surface 106 is disposed below, and substantially parallel with, the top surface of the hitch step (FIGS. 2A-2D). Accordingly, the flip down step 100 may be used in either the first position or the second position as a user may step on the non-slip surface of the first surface 104 or the second surface 106, respectively. The first and second surfaces 104, 106 of the flip down step 100 may be attached via welding, screws, or other fixed or detachable attachments.

The exemplary flip down step may include a step surface 108, a first bracket 110, and a second bracket 112. In some embodiments, the step surface 108 may be a frame portion connecting the first bracket 110 and the second bracket 112 and providing mounting points for the first surface 104 and the second surface 106. The first bracket 110 and the second bracket 112 may each be attached to the step 108 at an acute angle (e.g., 74 degrees). The first and second brackets 110, 112 may be continuous with the frame portion 108 or may be separate components attached, e.g., via welding.

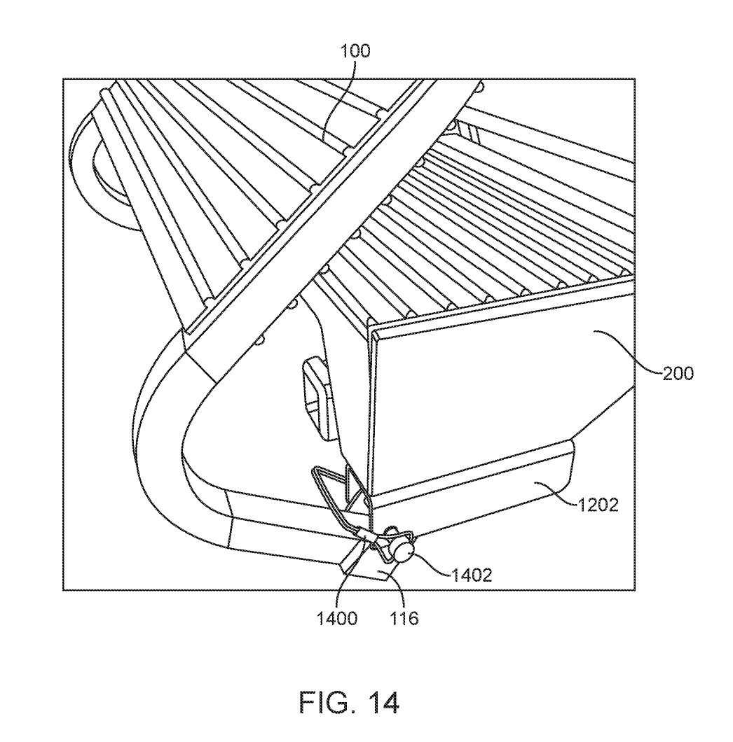

A first pivoting bracket 114 may be disposed at an end of the first bracket 110 distal from the step surface 108. A second pivoting bracket 116 may be disposed at an end of the second bracket 116 distal from the step surface 108. The first pivoting bracket 114 and the second pivoting bracket 116 may be identical. Each pivoting bracket 114, 116 may contain an elongated aperture 118. The elongated aperture 118 may receive a pin (e.g., pin 1402) therethrough such that rotation of the flip-down step 100 is restricted by contact between an outer edge 120 of the pivoting brackets 114, 116 and a flip-down step attachment bracket (FIG. 14). The pivoting bracket 110 is rotatably attached to the attachment bracket 1202. For example, on one side of the step system, the pivoting bracket 110 is rotatably attached to the attachment bracket 1202 via the pin 1402 inserted through the opening 118 of the bracket 110 and a corresponding opening 119 in attachment bracket 1202. The same method of attachment is used for the other side of the step system. The first and second pivoting brackets 112, 114 may be attached to the first and second brackets 110, 112, respectively, e.g., via welding.

FIG. 2A shows a top unassembled view of an exemplary hitch step 200 of the exemplary hitch step system. FIG. 2B shows a detail view of mounting holes about A in FIG. 2A. The hitch step 200 includes a top surface 202, a front surface 204, a right surface 206, a left surface 208, and bottom surfaces 210, 212. Bottom surfaces 210, 212 may include a plurality of apertures 214 for connecting to an optional flip-down step attachment bracket (FIG. 14). The surfaces 202, 204, 206, 208, 210, 212 of the hitch step 200 may be bent and attached (e.g., via welding) to form a formed part (FIGS. 3A-3D).

FIG. 3A shows a bottom plan view of a formed exemplary hitch step 200 of the exemplary hitch step system. FIG. 3B shows a front elevational view of the exemplary hitch step of FIG. 3A. FIG. 3C shows a right side elevational view of the exemplary hitch step of FIG. 3A. FIG. 3D shows a perspective view of the exemplary hitch step of FIG. 3A. The formed hitch step 200 has a top surface 202, a front surface 204, a right surface 206, a left surface 208, and bottom surfaces 210, 212 which form a step. In some embodiments, the top surface 202 may have a non-slip coating, pattern, and/or additional material applied thereon for use as a step by a user.

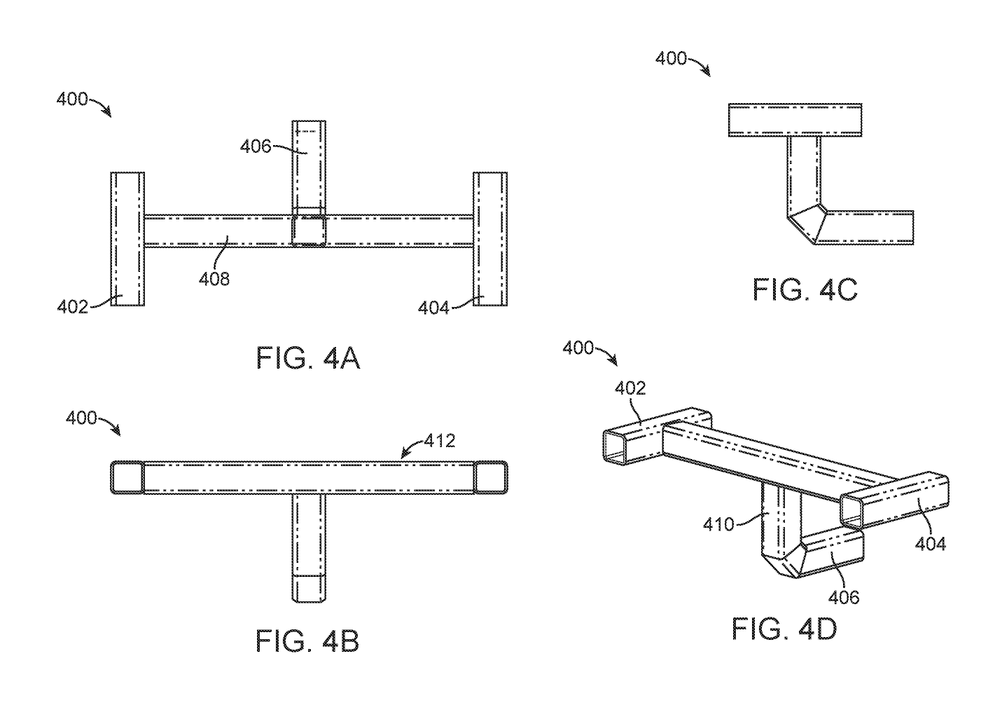

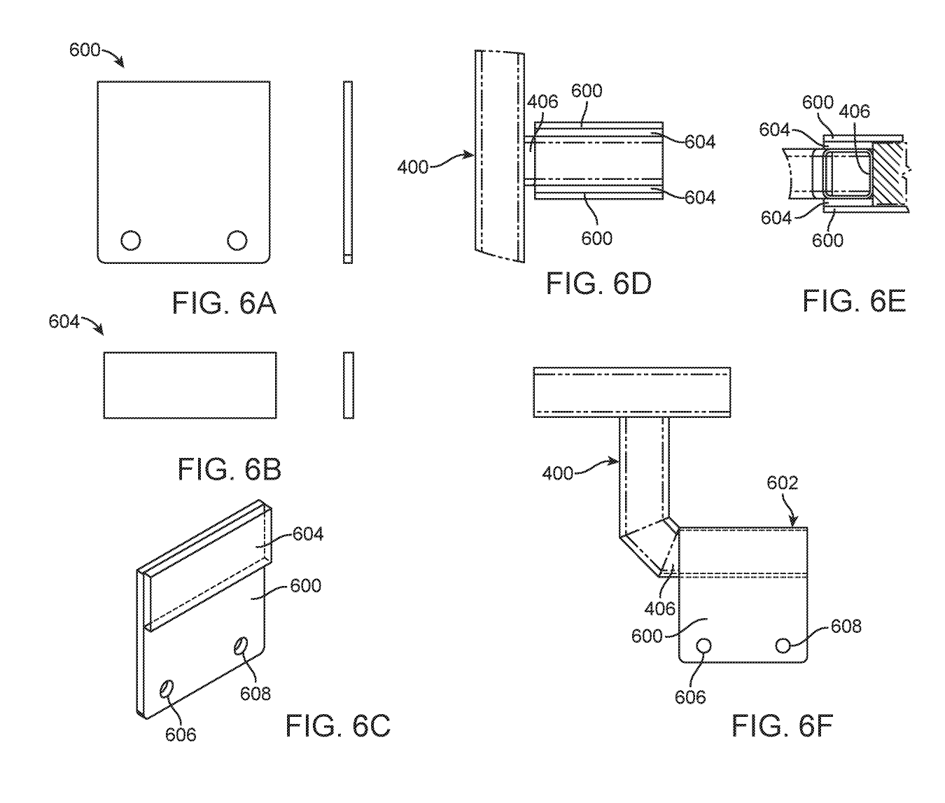

FIG. 4A shows a top plan view of an exemplary hitch step support 400 of the exemplary hitch step system. FIG. 4B shows a front elevational view of the exemplary hitch step support 400 of FIG. 4A. FIG. 4C shows a right side elevational view of the exemplary hitch step support 400 of FIG. 4A. FIG. 4D shows a perspective view of the exemplary hitch step support 400 of FIG. 4A. The hitch step support 400 includes a first support frame member 402, a second support frame member 404, a third support frame member 406, a fourth support frame member 408, and a fifth support frame member 410. The first support frame member 402, second support frame member 404, and third support frame member 406 are all substantially parallel along a longitudinal axis. The fourth support frame member 408 is substantially perpendicular to the first and second support frame members 402, 404. The fifth support frame member 410 is substantially perpendicular to both the fourth support frame member 408 and the third support frame member 406. The third frame member 406 is detachably attached to a hitch receiver tube of a hitch receiver via a saddle (FIG. 6F). The frame members of the hitch step support 400 may be bent and/or attached to one another, e.g., via welding.

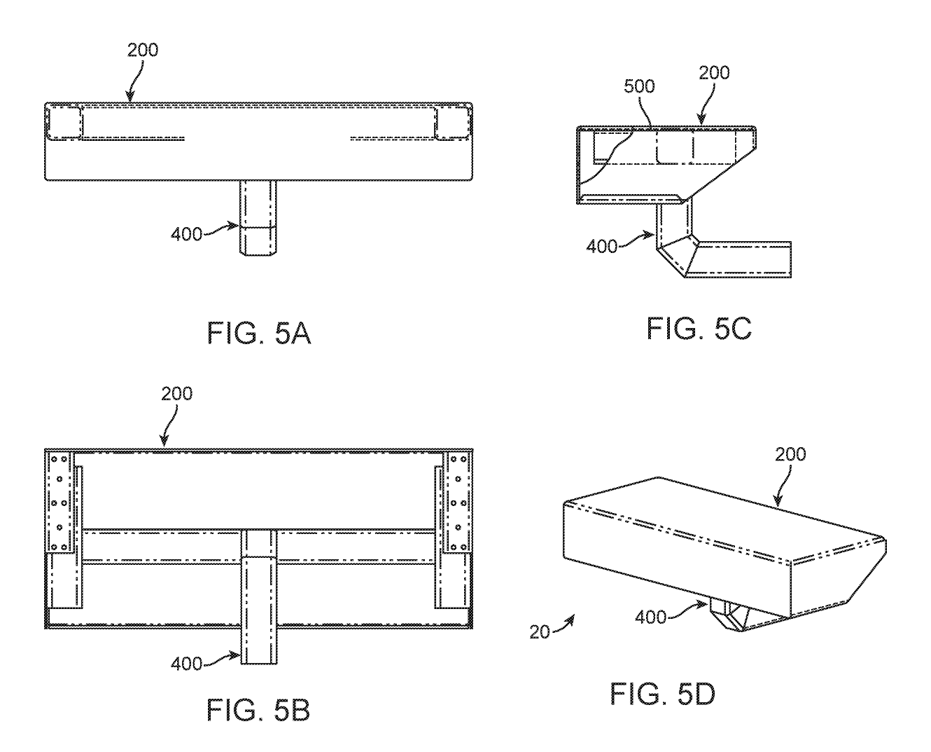

FIG. 5A shows a front elevational view of the exemplary hitch step 200 of FIG. 3A and the exemplary hitch step support 400 of FIG. 4A, with hidden parts shown in dashed lines. FIG. 5B shows a bottom plan view of the exemplary hitch step 200 of FIG. 3A and the exemplary hitch step support 400 of FIG. 4A, with hidden parts shown in dashed lines. FIG. 5C shows a right side elevational view of the exemplary hitch step 200 of FIG. 3A and the exemplary hitch step support 400 of FIG. 4A, with hidden parts shown in dashed lines. FIG. 5D shows a perspective view of the exemplary hitch step 200 of FIG. 3A and the exemplary hitch step support 400 of FIG. 4A. The top surfaces 500 of the first, second, and fourth support frame members 402,404,408 are attached to and support the inner surface of the hitch step 200. The hitch step support 400 may be fixedly attached to the hitch step 200, e.g., via welding. In some embodiments, the hitch step support 400 may be detachably attached to the hitch step 200, e.g., via bolts.

FIG. 6A shows an exemplary mounting plate 600 of a saddle mount 602 of the exemplary hitch step system. FIG. 6B shows an exemplary spacer plate 604 of the saddle mount 602 of the exemplary hitch step system. FIG. 6C shows a perspective view of the exemplary mounting plate 600 of FIG. 6A attached to the exemplary spacer plate 604 of FIG. 6B. FIG. 6D shows a top view of the exemplary mounting plate 600 of FIG. 6A and exemplary spacer plate 604 of FIG. 6B mounted on either side of the exemplary hitch step support 400 of FIG. 4A. FIG. 6E shows a cross-sectional view of the exemplary mounting plate 600 of FIG. 6A and exemplary spacer plate 604 of FIG. 6B attached on either side of the exemplary hitch step support 400 of FIG. 4A. FIG. 6F shows a right side elevational view of the exemplary mounting plate 600 of FIG. 6A attached to the exemplary hitch step support 400 of FIG. 4A. The mounting plate 600 may include a plurality of apertures 606, 608 for fitting a plurality of fasteners (e.g., bolts). The mounting plate 600 may be fixed to the spacer plate 604 (e.g., via welding). Two sets of mounting and spacer plates 600, 604 may fit on either side of the third frame member 406 of the hitch step support 400 to form the saddle mount 602. The saddle mount 602 may be used to detachably attach the hitch step system to a hitch receiver tube of a hitch receiver (FIGS. 12, 18, 19, 21, 22).

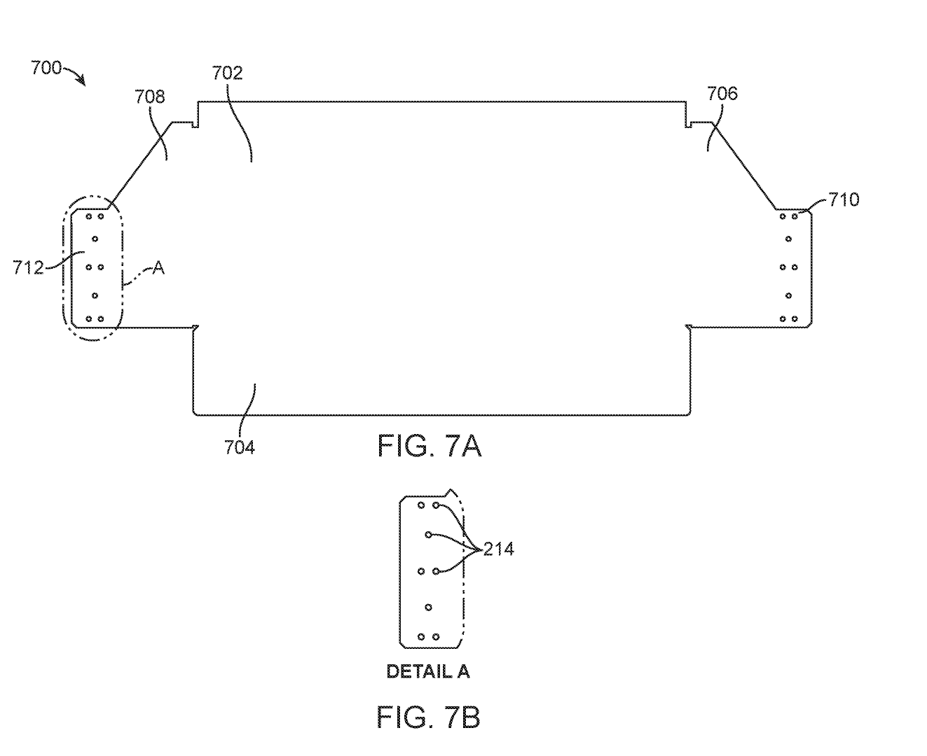

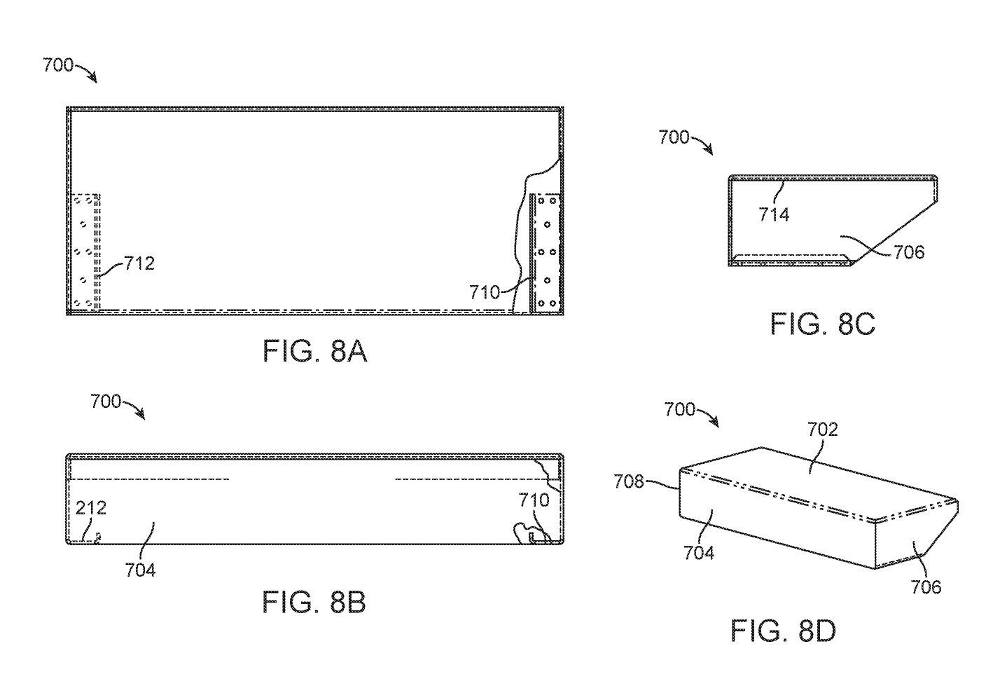

FIGS. 7A-11F show an alternate exemplary hitch step system having a variable vertical height relative to a hitch receiver. FIG. 7A shows a top unassembled view of an alternate exemplary hitch step 700 of an alternate exemplary hitch step system. FIG. 7B shows a detail view of mounting holes about A in FIG. 7A. The hitch step 700 includes a top surface 702, a front surface 704, a right surface 706, a left surface 708, and bottom surfaces 710, e.g., via bolts or welding. Bottom surfaces 710, 712 may include a plurality of apertures 714 for connecting to an optional flip-down step attachment bracket (FIG. 14). The surfaces 702, 704, 706, 708, 710, 712 of the hitch step 700 may be bent and attached (e.g., via welding) to form a formed part (FIGS. 8A-8D).

FIG. 8A shows a bottom plan view of an alternate formed exemplary hitch step 700 of the alternate exemplary hitch step system. FIG. 8B shows a front elevational view of the alternate exemplary hitch step 700 of FIG. 8A. FIG. 8C shows a right side elevational view of the alternate exemplary hitch step 700 of FIG. 8A. FIG. 8D shows a perspective view of the alternate exemplary hitch step 700 of FIG. 8A. The formed hitch step 700 has a top surface 702, a front surface 704, a right surface 706, a left surface 708, and bottom surfaces 710, 712 which form a step. In some embodiments, the top surface 702 may have a non-slip coating, pattern, and/or additional material applied thereon for use as a step by a user.

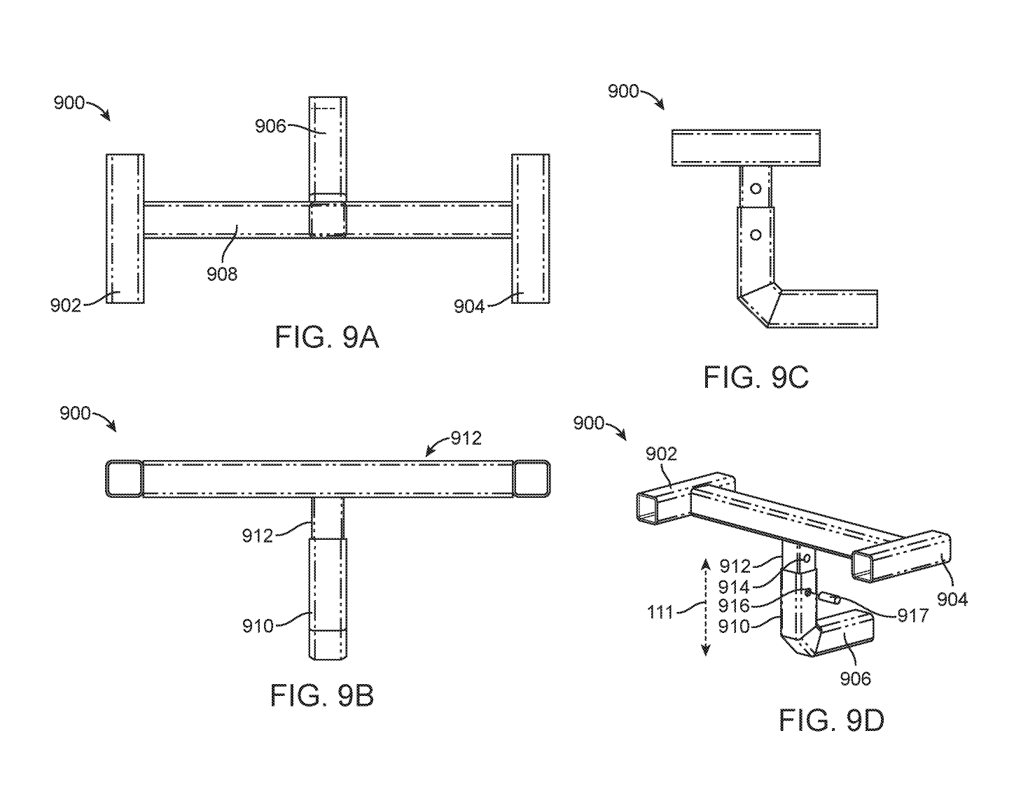

FIG. 9A shows a top plan view of an alternate exemplary hitch step support 900 having an adjustable vertical height of the alternate exemplary hitch step system. FIG. 9B shows a front elevational view of the alternate exemplary hitch step support 900 of FIG. 9A. FIG. 9C shows a right side elevational view of the alternate exemplary hitch step support 900 of FIG. 9A. FIG. 9D shows a perspective view of the alternate exemplary hitch step support 900 of FIG. 9A.

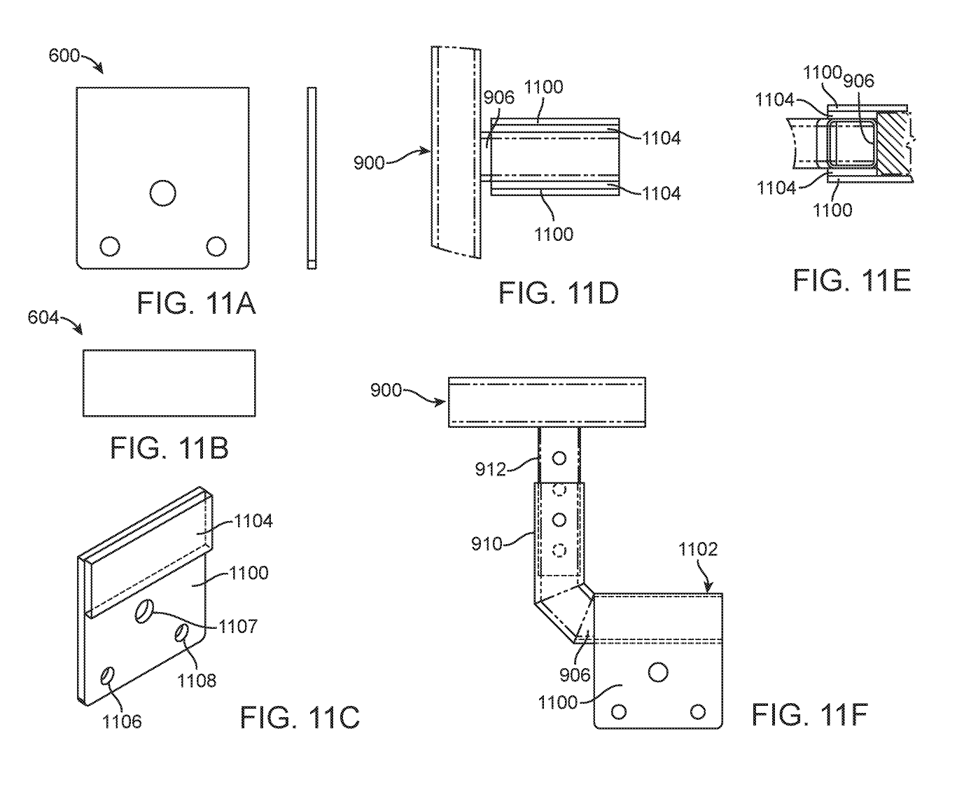

The hitch step support 900 includes a first support frame member 902, a second support frame member 904, a third support frame member 906, a fourth support frame member 908, a fifth support frame member 910, and a sixth support frame member 912. The first support frame member 902, second support frame member 904, and third support frame member 906 are all substantially parallel along a longitudinal axis. The fourth support frame member 908 is substantially perpendicular to the first and second support frame members 902, 904. The fifth and sixth support frame members 910, 912 are substantially perpendicular to both the fourth support frame member 908 and the third support frame member 906. The third frame member 906 is detachably attached to a hitch receiver tube of a hitch receiver via a saddle (FIG. 11F).

The fifth and sixth support members 910, 912 are substantially parallel about a longitudinal axis. Each of the fifth and sixth support members 910, 912 may have a plurality of apertures 914, 916 for adjusting the height of the top surface 912 of the hitch step support 900 relative to the third frame member 906. The sixth frame member 912 may slidably fit within the fifth frame member 910, in a telescopic manner as shown by dotted arrow 111 (FIG. 9D), for height adjustment. The frame member 912 can slide in and out of the frame member 910, wherein the frame member 910 functions as a sleeve for the frame member 912. In the embodiments shown, the frame members 910 and 912 have rectangular cross-sections.

Accordingly, the height of the hitch step (700, See FIG. 8D) and/or flip down step (100, See FIG. 1E) may be adjusted to an optimal level/height relative to the vehicle bed and/or ground, as desired by a user for entry to and/or access to an RV or another vehicle. One or more pins 917, or other device, may be secured through the plurality of apertures 914, 916 to secure the fifth and sixth frame members 910, 912 relative to one another. In some embodiments, the pin may be spring loaded.

FIG. 10A shows a front elevational view of the alternate exemplary hitch step 700 of FIG. 8A and the alternate exemplary hitch step support 900 of FIG. 9A, with hidden parts shown in dashed lines. FIG. 10B shows a bottom plan view of the alternate exemplary hitch step 700 of FIG. 8A and the alternate exemplary hitch step support 900 of FIG. 9A, with hidden parts shown in dashed lines. FIG. 10C shows a right side elevational view of the alternate exemplary hitch step 700 of FIG. 8A and the alternate exemplary hitch step support 900 of FIG. 9A, with hidden parts shown in dashed lines. FIG. 10D shows a perspective view of the alternate exemplary hitch step 700 of FIG. 8A and the alternate exemplary hitch step support 900 of FIG. 9A. The top surfaces 1000 of the first, second, and fourth support frame members 902, 904, 908 are attached to and support the inner surface of the hitch step 700.

FIG. 11A shows an alternate exemplary mounting plate 1100 of an alternate saddle 1102 of the alternate exemplary hitch step system. FIG. 11B shows an alternate exemplary spacer plate 1104 of the alternate saddle 1102 of the alternate exemplary hitch step system. FIG. 11C shows a perspective view of the alternate exemplary mounting plate 1100 of FIG. 6A attached to the alternate exemplary spacer plate 1104 of FIG. 6B. FIG. 11D shows a top view of the alternate exemplary mounting plate 1100 of FIG. 6A and alternate exemplary spacer plate 1104 of FIG. 6B mounted on either side of the alternate exemplary hitch step support 900 of FIG. 9A.

FIG. 11E shows a cross-sectional view of the alternate exemplary mounting plate 1100 of FIG. 11A and alternate exemplary spacer plate 1104 of FIG. 11B attached on either side of the alternate exemplary hitch step support 900 of FIG. 9A. FIG. 11F shows a right side elevational view of the alternate exemplary mounting plate 1100 of FIG. 11A attached to the alternate exemplary hitch step support 900 of FIG. 9A. The mounting plate 600 may include a plurality of apertures 1106, 1107, 1108 for fitting a plurality of fasteners (e.g., bolts). The mounting plate 1100 may be fixed to the spacer plate 1104 (e.g., via welding). Two sets of mounting and spacer plates 1100, 1104 may fit on either side of the third frame member 906 of the hitch step support 1100 to form the saddle 1102. The saddle 1102 may be used to detachably attach the hitch step system to a hitch receiver tube of a hitch receiver (FIG. 12).

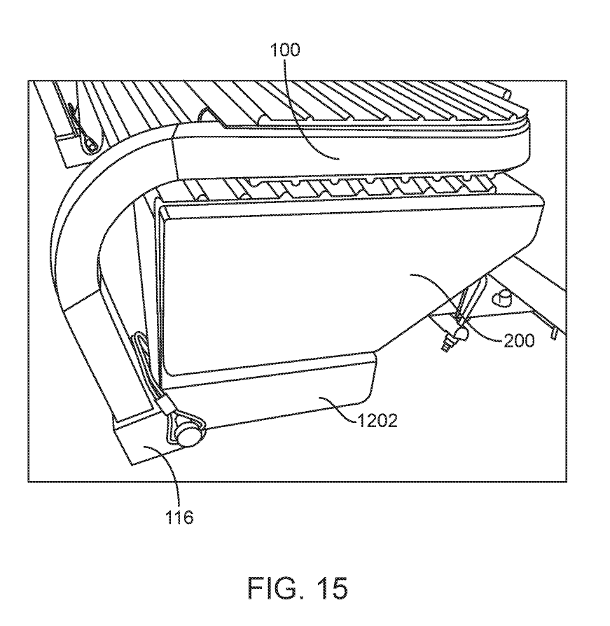

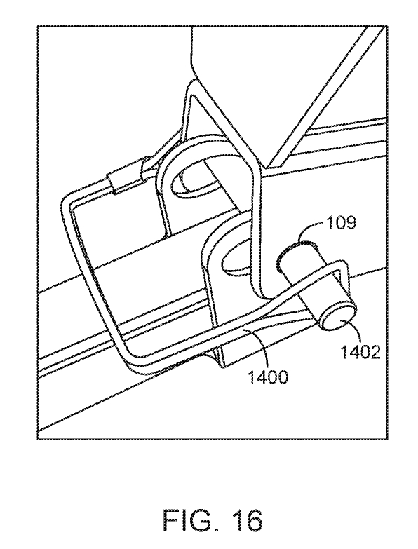

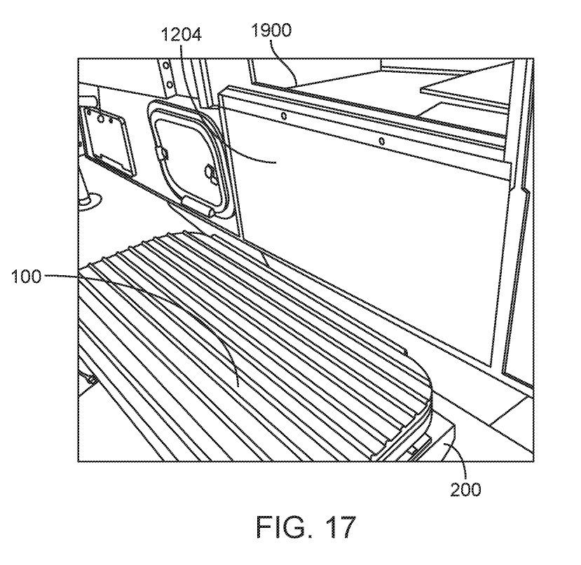

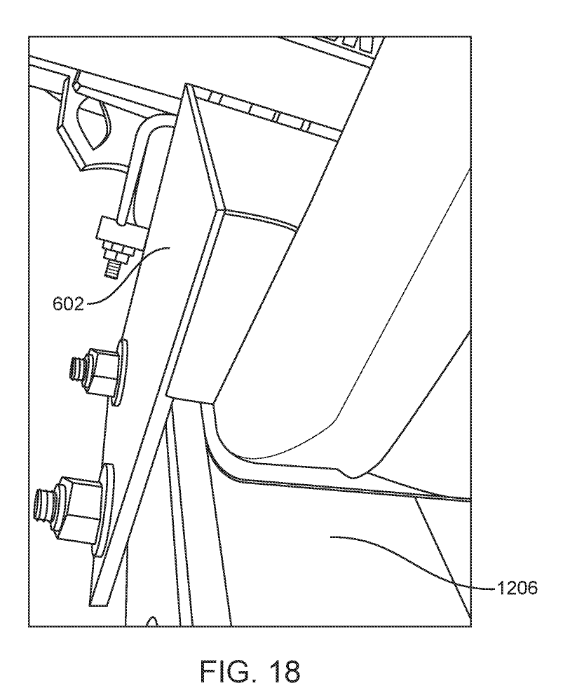

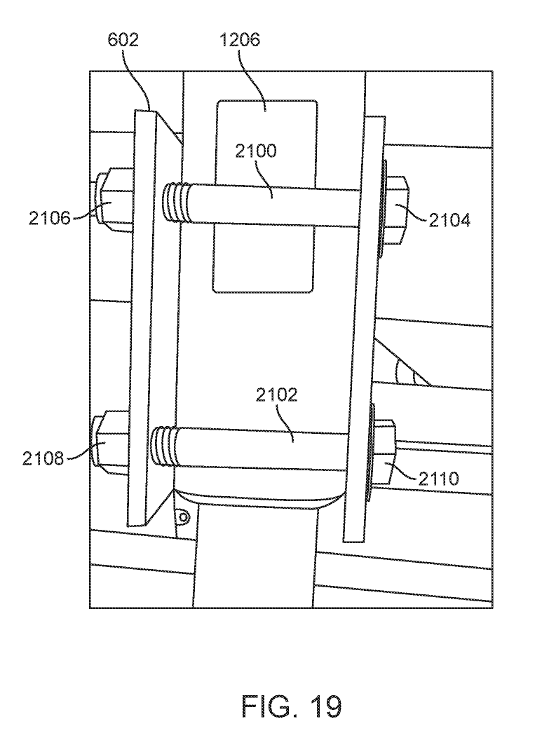

FIG. 12 shows a perspective view of the exemplary hitch step system 1201. FIG. 13 shows another perspective view of the exemplary hitch step system 1201. FIG. 14 shows a perspective view of the exemplary pivoting bracket of the exemplary flip down step limiting further rotational movement of the exemplary flip down step relative to the exemplary hitch step. FIG. 15 shows a perspective view of the exemplary flip down step in a first position. FIG. 16 shows a perspective view of the exemplary pivoting bracket of the flip down step. FIG. 17 shows a perspective view of the exemplary hitch step system relative to a door in a recreational vehicle (RV). FIG. 18 shows a perspective view of the exemplary hitch step support and exemplary saddle attached to a hitch receiver tube of a hitch receiver. FIG. 19 shows a bottom view of the exemplary hitch step support and exemplary saddle attached to a hitch receiver tube of a hitch receiver.

The exemplary hitch step system 1201 includes the hitch step 200, the optional flip-down step 100, the hitch step support 400, and the saddle mount 602. The pivoting brackets 114, 116 attach to flip-down step attachment brackets 1200, 1202. The flip-down step attachment brackets 1200, 1202 are attached to the hitch step 200 via bottom surfaces (210, 212, See FIG. 2A) having a plurality of apertures. In some embodiments, the flip-down step 100 and flip-down step attachment brackets 1200, 1202 may be removed entirely from the hitch step system 1201.

The hitch step system 1201 may be mounted on a hitch receiver tube 1206 of a hitch receiver 1208 via the saddle mount 602. Accordingly, the hitch receiver 1208 has an open end 1210 that may still be used to accept additional accessories, such as a bike rack or a cargo carrier, while providing a step for entry to a recreational vehicle (RV) 1204 or another vehicle having a hitch receiver mounted thereon. Unlike traditional mounts that may occupy the end 1210 of the hitch receiver 1208, the disclosed hitch step system 1201 may be detachably attached to the hitch receiver tube 1206, which does not inhibit further use of the hitch receiver 1208, while providing one or more steps 100, 200 for a user to enter the RV 1204 or another vehicle. The height and number of steps used may vary based on a doorway (vehicle bed, entry floor) 1900 location of the RV 1204 along with personal preference, user height, user medical needs, etc.

A plurality of fasteners 2100, 2102, such as bolts 2104, 2110 and nuts 2106, 2108, may be fit through the plurality of apertures in the saddle mount 602 to tighten the saddle mount 602 around the hitch receiver tube 1206. The hitch step system 1201 may be detachably attached from the hitch receiver 1208 of the RV when not needed or to mount on various vehicles having hitch receivers. A removable security latch spring 1400 may be attached to each pin 1402 of each pivoting bracket 114, 116 to ensure that the flip-down step does not rotate relative to the hitch step 200 unless intended to by the user, such as when driving.

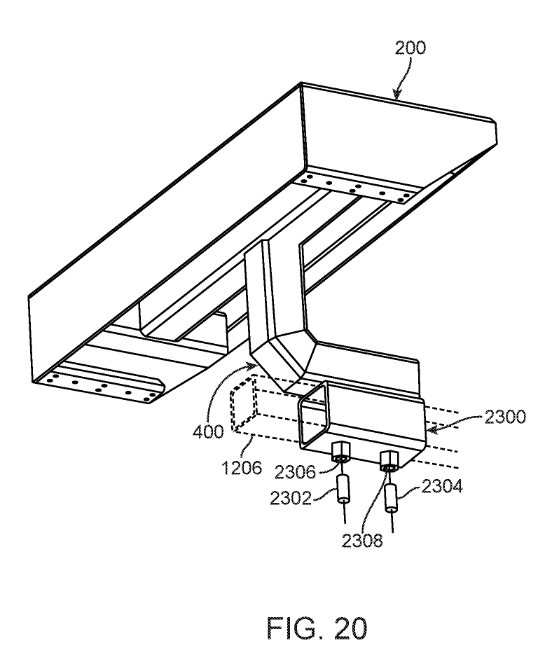

FIG. 20 shows a perspective view of the exemplary hitch step 200 of FIG. 3A and the exemplary hitch step support 400 of FIG. 4A. The hitch step support 400 may be attached to a sleeve 2300 via one or more fasteners such as screws 2302, 2304 (e.g., knurl-grip cup point set screws made of alloy steel and having a ½″-20 thread and a length of 1¼″).

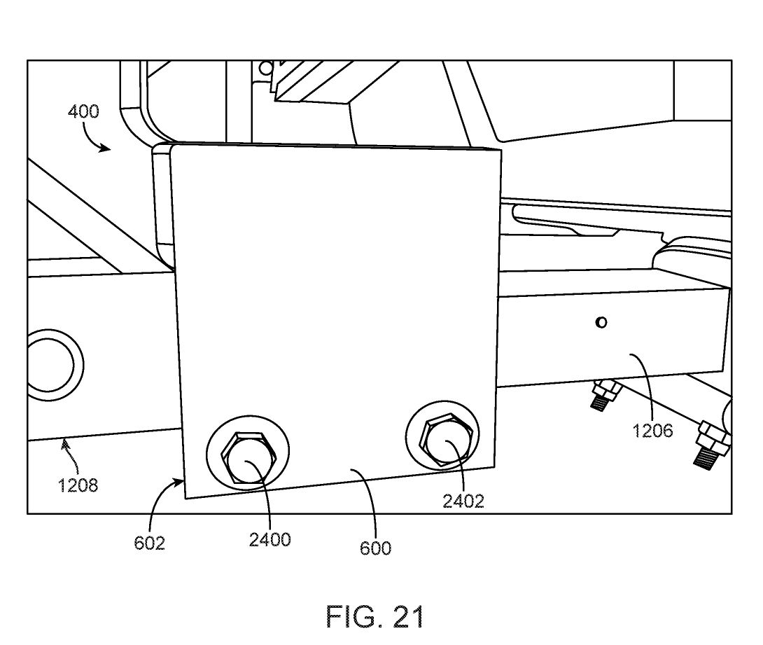

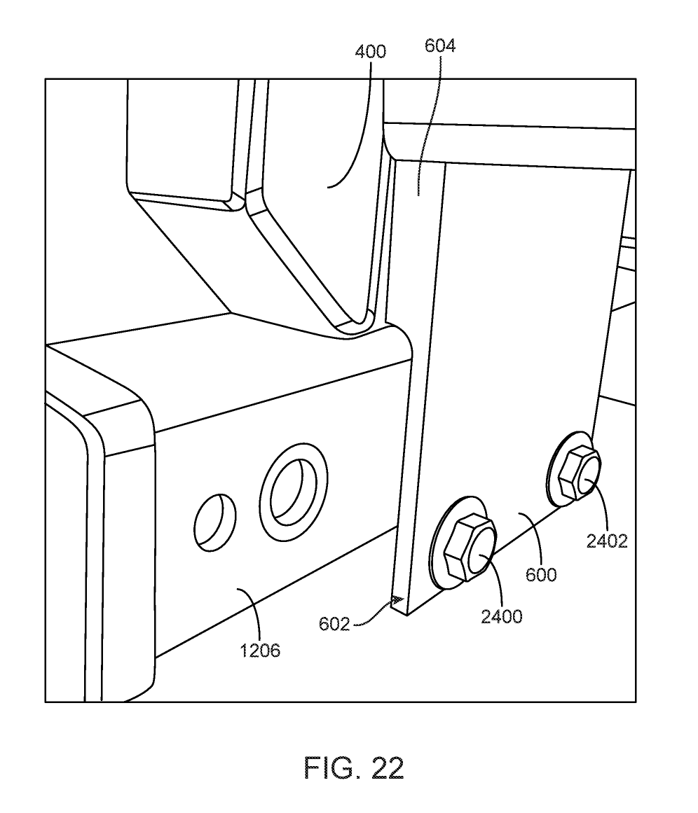

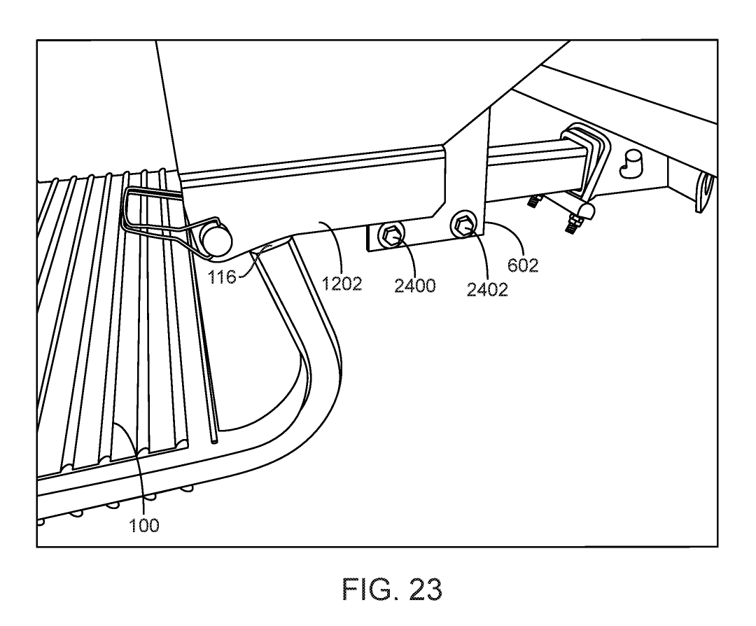

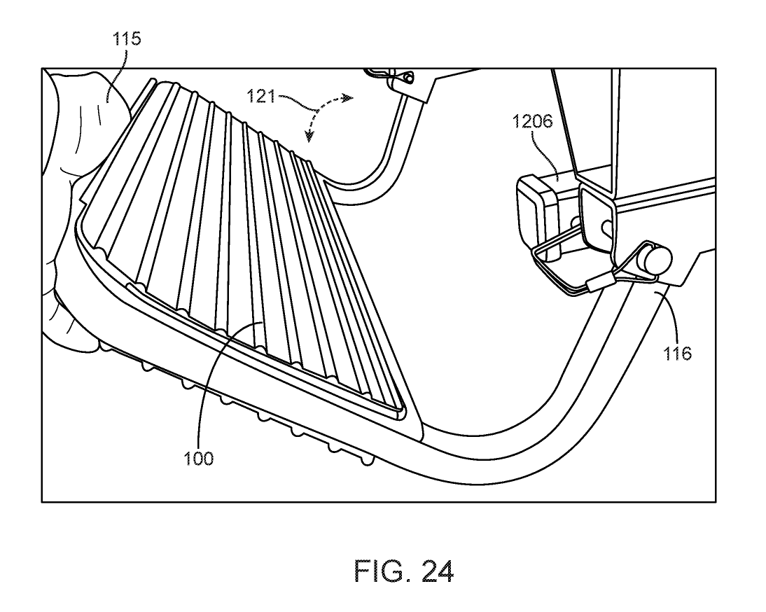

FIG. 21 shows a perspective view of the saddle mount 602 of the exemplary hitch step system attached to the hitch receiver tube 1206 of the hitch receiver 1208. FIG. 22 shows an additional perspective view of the saddle mount 602 of the exemplary hitch step system attached to the hitch receiver tube 1206 of the hitch receiver 1208. The hitch receiver tube 1206 has an open end, as shown in FIGS. 12-13 that may still be used to accept additional accessories. Unlike traditional mounts that may occupy this open end of the hitch receiver tube 1206, the disclosed hitch step system may be detachably attached to the hitch receiver tube 1206 via saddle mount 602. As a result, further use of the hitch receiver 1208 is not inhibited. FIG. 23 shows a perspective view of the exemplary hitch step system with the exemplary flip down step 100 in a lowered or second position. FIG. 24 shows a perspective view of the exemplary hitch step system with the exemplary flip down step 100 being lowered/raised manually by a user 115 as shown by dotted arrow 121 in FIG. 24. The hitch step system may be mounted on the hitch receiver tube 1206 of the hitch receiver 1208 via the saddle mount 602. The saddle mount 602 may be used to detachably attach the hitch step system to the hitch receiver tube 1206 of the hitch receiver 1208. The mounting plate 600 may include a plurality of apertures (FIG. 6F) for fitting a plurality of fasteners 2400, 2402, such as bolts. The mounting plate 600 may be fixed to the spacer plate 604 (e.g., via welding). Two sets of mounting and spacer plates 600, 604 may fit on either side of the hitch step support 400 to form the saddle mount 602. The pivoting bracket 116 of the flip down step 100 prevents the hitch step from swinging down during the transition from the first position to the second position, which could cause injury to a user. The flip down step may be secured in the first position when not in use.

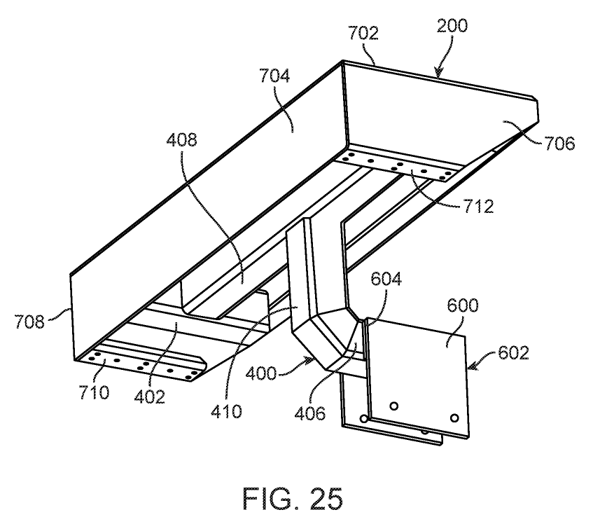

FIG. 25 shows a perspective view of the exemplary hitch step system, according to one embodiment. In one embodiment shown in FIG. 20, the hitch mount comprises a sleeve 2300. The sleeve 2300 has a rectangular cross-section having an interior sized and shaped to slidably receive a hitch tube receiver, such as industry standard 2″ inch hitch tube receivers, or 1.25″ inch hitch tube receivers, etc. In one embodiment shown in FIG. 20, the interior of the sleeve 2300 is snug with the exterior walls of the hitch tube receiver to reduce slippage and vibration. The sleeve 2300 includes threaded openings 2306, 2308 for inserting screws 2302, 2304 therethrough and tightening the screws 2302, 2304 such that the tip of the screws urge against at least one wall of the hitch tube receiver 1206 depicted in dashed lines, within the sleeve 2300, such that the sleeve 2300 remains stationary relative to the hitch tube receiver 1206 therein.

In one embodiment shown in FIG. 25, the hitch mount comprises a saddle 602. The saddle 602 may include two pairs of side walls 600 and spacer plates 604 attached to the hitch step support 400. The side walls 600 may be welded to one or more spacer plates 604. The one or more spacer plates 604 may be welded to frame member 406 of the hitch step support 400. Opposing sides of the frame member 406 may have spacer plates 406 and/or side walls 604 of the saddle 602 welded thereon such that the spacer plates 604 and frame members 600 of the saddle 602 are substantially parallel to one another and form an opening for receiving a portion of the hitch receiver tube having a substantially constant width. Accordingly, the saddle 602 may be in contact with opposing sidewalls of the hitch receiver tube to form a partial friction fit. The saddle 602 may be secured to the hitch receiver tube via one or more fasteners, as shown in FIG. 19, fitting through the apertures in the side walls 604 of the saddle 602.

As noted, hitch step system 10 is disclosed herein includes: a hitch mount (e.g., saddle 602 or sleeve 2300) configured to be mounted to a hitch receiver tube 1206; where the hitch mount has a body comprising an opening for slidably receiving a portion of the hitch receiver tube 1206 therein; and where an open end 1210 of the hitch receiver tube 1206 remains available to receive a hitch attachment. As noted, the hitch mount body may include a sleeve element 2300. The sleeve element 2300 may include a plurality of threaded openings 2306, 2308. The system may also include a plurality of fasteners 2302, 2304, where the plurality of fasteners 2302, 2304 are inserted through the plurality of threaded openings 2306, 2308 to urge the plurality of fasteners 2302, 2304 against at least one wall of the hitch receiver tube 1206 within the sleeve element 2300 such that the sleeve element 2300 remains stationary relative to the hitch receiver tube 1206.

In another system embodiment, the hitch mount body comprises a saddle element 602. The saddle element 602 may be fixedly attached to a hitch step support 400. The hitch step support 400 may include a first support frame member 902, a second support frame member 904, a third support frame member 906, a fourth support frame member 908, a fifth support frame member 910, and a sixth support frame member 912. The first support frame member 902, the second support frame member 904, and the third support frame member 904 may all be substantially parallel along a longitudinal axis; where the fourth support frame member 908 may be substantially perpendicular to the first 902 and second 904 support frame members; and where the fifth 910 and sixth 912 support frame members may be substantially perpendicular to both the fourth support frame member 908 and the third support frame member 906. The third frame member 906 may be fixedly attached to the saddle 602.

In some system embodiments, the hitch step support 400 may have an adjustable vertical height 111 relative to the hitch receiver tube. The system may also include a hitch step 200 including a top surface 202 and a bottom surface 210,212, where the hitch step support 400 may be attached to the hitch step 200. The system may also include a flip-down step 100 disposed above the hitch step 200 in a first position and below the hitch step 200 in the second position. Some system embodiments may include a plurality of pivoting brackets 114, 116, where the flip-down step 100 may be detachably attached to the bottom surface 210, 212 of the hitch step 200 by the plurality of pivoting brackets 114, 116 rotatably attached to flip-down step attachment brackets 1200, 1202.

The saddle element 602 may include a plurality of apertures, and the saddle element 602 may be secured about the hitch receiver tube via a plurality of fasteners 2100, 2102 fitting through the apertures in side walls 600 of the saddle 602. The saddle element 602 may include two pairs of side walls 600 and spacer plates 604 attached to the hitch step support 400, where the spacer plates 604 and side walls 600 of the saddle may be substantially parallel to one another and form an opening for receiving a portion of the hitch receiver tube 1206 having a substantially constant width.

One or more of the drawings includes marking indicating example number of elements and features, physical dimensions, sizes, measurements (in inches), angles, structural relationships, etc. Embodiments of the disclosed hitch step system herein are not limited to said examples.

The structural elements of the hitch step system may be made from rigid materials such as metals (e.g., aluminum, iron, etc.).

Those skilled in the art will appreciate that various adaptations and modifications of the described preferred embodiments can be configured without departing from the scope and spirit of the improved pressure switch system described herein. Therefore, it is to be understood that, within the scope of the embodiments, the switch system may be practiced other than as specifically described herein.

1. A hitch step system comprising:
a hitch mount configured to be mounted to a hitch receiver tube;
wherein the hitch mount has a body comprising an opening for slidably receiving a portion of the hitch receiver tube therein;
wherein an open end of the hitch receiver tube remains available to receive a hitch attachment.

2. The system of claim 1, wherein the hitch mount body comprises a sleeve element.

3. The system of claim 2, wherein the sleeve element comprises a plurality of threaded openings.

4. The system of claim 3 further comprising:
a plurality of fasteners, wherein the plurality of fasteners are inserted through the plurality of threaded openings to urge the plurality of fasteners against at least one wall of the hitch receiver tube within the sleeve element such that the sleeve element remains stationary relative to the hitch receiver tube.

5. The system of claim 1, wherein the hitch mount body comprises a saddle element.

6. The system of claim 5, wherein the saddle element is fixedly attached to a hitch step support.

7. The system of claim 6, wherein the hitch step support comprises a first support frame member, a second support frame member, and a fourth support frame member, wherein the first support frame member and the second support frame member are substantially parallel along a longitudinal axis, wherein the fourth support frame member is substantially perpendicular to the first and second support frame members, and wherein the first, second, and fourth support frame members form an H-shaped support.

8. The system of claim 7, wherein the hitch step support further comprises a third support frame member, a fifth support frame member, and a sixth support frame member, wherein the first support frame member, the second support frame member, and the third support frame member are all substantially parallel along a longitudinal axis;
wherein the fifth and sixth support frame members are substantially perpendicular to both the fourth support frame member and the third support frame member; and
wherein the third, fifth, and sixth support frame members form an L-shaped support;
wherein the fifth support frame member of the L-shaped support is attached to the fourth support frame member of the H-shaped support proximate a center of the fourth support frame member.

9. The system of claim 7, wherein the third frame member is fixedly attached to the saddle.

10. The system of claim 6, wherein the hitch step support has an adjustable vertical height relative to the hitch receiver tube.

11. The system of claim 6, further comprising:
a hitch step comprising a top surface and a bottom surface, wherein the hitch step support is attached to the hitch step.

12. The system of claim 11, further comprising:
a flip-down step disposed above the hitch step in a first position and below the hitch step in the second position.

13. The system of claim 12, further comprising:
a plurality of pivoting brackets, wherein the flip-down step is detachably attached to the bottom surface of the hitch step by the plurality of pivoting brackets rotatably attached to flip-down step attachment brackets.

14. The system of claim 5, wherein the saddle element comprises a plurality of apertures, and wherein the saddle element is secured about the hitch receiver tube via a plurality of fasteners fitting through the apertures in side walls of the saddle.

15. The system of claim 6, wherein the saddle element comprises two pairs of side walls and spacer plates attached to the hitch step support, wherein the spacer plates and side walls of the saddle are substantially parallel to one another and form an opening for receiving a portion of the hitch receiver tube having a substantially constant width.

16. A hitch step system comprising:
a hitch mount configured to be mounted to a hitch receiver tube, wherein the hitch mount has a body comprising an opening for slidably receiving a portion of the hitch receiver tube therein; and
a hitch step support fixedly attached to the hitch mount body, wherein the hitch step support has an adjustable vertical height relative to the hitch receiver tube;
wherein an open end of the hitch receiver tube remains available to receive a hitch attachment.

17. The hitch step system of claim 16, wherein the hitch step support further comprises:
a first support frame member, a second support frame member, a third support frame member, a fourth support frame member, a fifth support frame member, and a sixth support frame member;
wherein the first support frame member, second support frame member, and third support frame member are all substantially parallel along a longitudinal axis;
wherein the fourth support frame member is substantially perpendicular to the first and second support frame members;
wherein the fifth and sixth support frame members are substantially perpendicular to both the fourth support frame member and the third support frame member;
wherein the fifth and sixth support frame members are substantially parallel about a longitudinal axis;
wherein the first, second, and fourth support frame members form an H-shaped support;
wherein the third and fifth support frame members for an L-shaped support;
wherein the sixth support frame member is attached to the fourth support frame member of the H-shaped support proximate a center of the fourth support frame member;
wherein each of the fifth and sixth support frame members have a plurality of apertures; and
wherein the sixth frame member of the L-shaped support slidably fits within the fifth frame member, in a telescopic manner for height adjustment.

18. The hitch step system of claim 17, further comprising a pin, wherein the pin is secured through the plurality of apertures of the fifth and sixth support frame members to secure the fifth support frame member relative to the sixth support frame member.

19. A hitch step system comprising:
a hitch mount configured to be mounted to a hitch receiver tube, wherein the hitch mount has a body comprising an opening for slidably receiving a portion of the hitch receiver tube therein; and
a hitch step support fixedly attached to the hitch mount body;
a hitch step attached to the hitch step support; and
a flip-down step rotatably mounted to the hitch step, wherein the flip-down step is disposed above the hitch step in a first position and below the hitch step in a second position;
wherein an open end of the hitch receiver tube remains available to receive a hitch attachment when the flip down step is in the first position.

20. The hitch step system of claim 19, further comprising:
a plurality of flip-down step attachment brackets attached to a bottom surface of the hitch step; and
a plurality of pivoting brackets attached to the flip-down step, wherein the plurality of pivoting brackets are detachably attached to the plurality of flip-down step attachment brackets.
